(19) United States
(12) Patent Application Publication
(10) Pub. No.: US 2011/0071872 A1
(43) Pub. Date: Mar. 24, 2011

(54) SYSTEM AND METHOD FOR INFRASTRUCTURE RISK ASSESSMENT AND/OR MITIGATION

(76) Inventors: Lori Frantzve, Scottsdale, AZ (US); Lawrence R. Guinta, Scottsdale, AZ (US)

(21) Appl. No.: 12/760,400

(22) Filed: Apr. 14, 2010

Related U.S. Application Data
(60) Provisional application No. 61/169,938, filed on Apr. 16, 2009.

(51) Int. Cl. G06Q 10/00

(52) U.S. Cl. 705/7.28

(57) ABSTRACT

Provided is a method of assessing reliability of an infrastructure entity. The method includes providing production data for an entity, assessing how the entity is expected to respond to a disturbing event, adjusting production data based on how the entity is expected to respond to the disturbing event, providing, in a graphical display of a computer system, a display indicative of the adjusted production data, determining a reliability of the entity based on the adjusted production data, and recommending an action for the entity based on the display indicative of the determined reliability.

### PRIORITY CLAIM

This application claims priority to U.S. Provisional Patent No. 61/169,938 entitled “SYSTEM AND METHOD FOR INFRASTRUCTURE RISK ASSESSMENT AND/OR MITIGATION” filed on Apr. 16, 2009.

### BACKGROUND

1. Field of the Invention

The present invention generally relates to various methods and apparatus for assessing organizational process or system. The term “assessing,” as used herein, refers to gathering information about, and/or measuring or evaluating, at least one organizational process or system.

2. Description of Related Art

Large entities such as corporations, professional associations, and government units typically rely heavily on operations of their infrastructure to run efficiently and reliably. As used herein, “infrastructure” may refer to the physical and organizational structures needed for the operation of a society or enterprise, or the services and facilities necessary for an economy to function, The term typically refers to the technical structures that support a society, such as roads, water supply, sewers, power grids, telecommunications, and so forth. Viewed functionally, infrastructure facilitates the production of goods and services; for example, roads enable the transport of raw materials to a factory, and also for the distribution of finished products to markets. The term “critical infrastructure” refers to infrastructure elements that, if significantly damaged or destroyed, would cause serious disruption of the dependent system or organization. In the case of an airline, for instance, a critical infrastructure may include an electronic booking system. In the case of a nation as a whole, power infrastructure elements may be considered critical infrastructure. For example, with regard to a nation such as the United States, refineries, oil and gas transport systems, power generation facilities, power distribution systems, if destroyed or operating at a reduced capacity, could create a significant disruption to part or all of the nation, and could leave the nation vulnerable economic slowdowns or even attack. Reduced operating capacity or destruction may be a result of an internal failure, a natural disaster, sabotage, a terrorist attack, or the like.

In the case of disruptions in operations, large entities often rely on in-house divisions, subsidiaries, departments, and/or systems, as well as third parties to resolve the disruption. For example, in the case of a refinery, when a production component, such as a catalytic cracker, is not functioning properly, an in-house engineering department may act to repair the catalytic cracker. In a situation, however, in which the catalytic cracker requires significant overhaul or is destroyed, the entity may rely on various suppliers to provide parts or a completely new catalytic cracker. Such repair or replacement can require weeks or months, during which the refinery may be operating at significantly reduced output. Accordingly, entities such as refineries may have one or more contingency plans in place in an attempt to avoid significant disruption to operations in the case of a disturbance. Although a refinery may be directly concerned with their specific infrastructure, the nation as a whole may also be concerned with a larger portion or an entirety of the infrastructure, including multiple refineries and similar production facilities. For example, in case where multiple refineries are taken off-line due to a catastrophic event, such as a hurricane, the nation's infrastructure may be jeopardized, and the government generally desires to minimize disruption to the nation as a whole. In the case of oil and gas refineries, the government may be concerned with maintaining at least a minimal level of refining capacity to ensure enough fuel is produced for the operation of the nation's critical transportation systems.

To address potential disruptions of an infrastructure, entities often spend considerable amount of time and money assessing and determining how the infrastructure can be improved to better withstand disruptions. Assessing may include surveying the current state of an entity to identify areas of risk. In the case of entities that rely on suppliers of goods and services, one method of assessment involves asking representatives of the suppliers or representatives who have worked with the suppliers, to answer questions and to provide information concerning organizational processes or systems used by the supplier. Such surveys may be used to assess characteristics of the supplier, and ultimately the ability of the entity to withstand disruptions. Although these surveys may provide insight to the ability of the particular entity to withstand a disruption, they may not take into other considerations, such as those external factors beyond the entities control or knowledge that may impact the ability to withstand a disruption. Moreover, in the case of a nation, for instance, the information gained in the surveys may not take into account interrelations and interdependencies of various infrastructure components. Accordingly, even where extensive surveys have been conducted, the resulting data may be incomplete and disjointed such that the true ability for an individual entity or several entities to withstand a disruption is not known, or not readily decipherable. For example, an assessment of a single refinery may not account for simultaneous disruptions at other refineries and, thus, an overall impact of a disruption can not be assessed and determined. Unfortunately, if the assessment is not performed accurately and in a decipherable manner, it may negatively impact an ability to identify and correct potential weak areas of infrastructure.

Accordingly, it is desirable to provide systems and methods that are conducive to the acquisition of data, the assessment of data, and output of resulting data such that an entity's infrastructure can be more accurately and readily assessed. Moreover, it is desirable to provide systems and methods that are conducive to identifying and addressing areas of risk related to the entity and infrastructure.

### SUMMARY

Various embodiments of assessing risks associated with critical infrastructure entities and related systems, apparatus, and methods are described. In one embodiment, provided is a method of assessing reliability of an infrastructure entity. The method includes providing production data for an entity, assessing how the entity is expected to respond to a disturbing event, adjusting production data based on how the entity is expected to respond to the disturbing event, providing, in a graphical display of a computer system, a display indicative of the adjusted production data, determining a reliability of the entity based on the adjusted production data, and recommending an action for the entity based on the display indicative of the determined reliability.

In another embodiment, provided is a computer readable storage medium having computer instructions stored thereon. The computer instructions are executable to implement a method of assessing reliability of an infrastructure entity. The method includes providing production data for an entity, assessing how the entity is expected to respond to a disturbing event, adjusting production data based on how the entity is expected to respond to the disturbing event, providing, in a graphical display of a computer system, a display indicative of the adjusted production data, determining a reliability of the entity based on the adjusted production data; and recommending an action for the entity based on the display indicative of the determined reliability.

In yet another embodiment, provided is a method of assessing reliability of an infrastructure entity. The method includes providing production data for an entity, assessing how the entity is expected to respond to a disturbing event, adjusting the production data based on how the entity is expected to respond to the disturbing event, providing, in a graphical display of a computer system, a display indicative of the adjusted production data, determining a reliability of the entity based on the adjusted production data, and recommending an action for the entity based on the display indicative of the determined reliability.

### BRIEF DESCRIPTION OF THE DRAWINGS

Advantages of the present invention will become apparent to those skilled in the art with the benefit of the following detailed description and upon reference to the accompanying drawings in which:

FIG. 1 is a graph that illustrates production data in accordance with embodiments of the present technique.

FIG. 2A is a diagram that illustrates a supply chain in accordance with embodiments of the present technique.

FIG. 2B is a table that illustrates entities and information related to their supply chain in accordance with embodiments of the present technique.

FIG. 3 is a graph that illustrates survivability and resiliency for one or more entities in accordance with embodiments of the present technique.

FIG. 4 is a graph that illustrates trending data for survivability and resiliency for one or more entities in accordance with embodiments of the present technique.

FIG. 5 is a graph that illustrates thresholding of survivability and resiliency for one or more entities in accordance with embodiments of the present technique.

FIG. 6 is an illustration of a computer system in accordance with embodiments of the present technique.

FIG. 7 is a flowchart that illustrated a method in accordance with embodiments of the present technique.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims,

### DETAILED DESCRIPTION OF ILLUSTRATIVE EMBODIMENTS

As discussed in more detail below, certain embodiments of the present technique include a system and method for infrastructure risk assessment and/or mitigation. In certain embodiments, production data for an entity is provided. In some embodiments, providing production data comprises acquiring data by having representatives within the entity, entity representatives who have worked with suppliers, and/or suppliers to answer questions and to provide information concerning organizational processes or systems used by the entity and/or the supplier. In certain embodiments, the production data, including information concerning organizational processes or systems used by the entity and/or the supplier, is used to provide a representation of how an entity's production may be affected by a disrupting event. In some embodiments, an assessment and determination of how an entity's production is expected to respond to a disrupting event includes assessing whether or not there is a conflict in the entities supply chain that may affect the production of the entity. In some embodiments, the effect is further represented into multiple segments, including a period of declining production and a period that includes a return to normal or restored production levels. In certain embodiments, a survivability is provided that is indicative of the period of initial decline in production and a resiliency is provided that is indicative of the period of a return to normal or restored production. In some embodiments, a reliability of the entity is based on the expected response of the entity to the disrupting event. In certain embodiments, the reliability is based on one or both of the survivability and the resiliency. In some embodiments, an index is provided for survivability, resiliency, and/or reliability. In certain embodiments, one or more graphical displays are provided of survivability, resiliency, and/or reliability (e.g., their indices) such that a user can readily assess and determine how an entity is expected to respond to a disrupting event. In some embodiments, graphs, charts, and/or tables are provided that include a display of various relations between survivability, resiliency, and/or reliability and or their indices. In some embodiments, assessments can be made based on the provided display of data to determine what entities may need to address production issues that may occur after a disrupting event.

As used herein, the term “infrastructure” may refer to the physical and organizational structures needed for the operation of a society or enterprise, or the services and facilities necessary for an economy to function. As used herein, “entity” may refer to one or more organizational structures needed for the operation of a society or enterprise, or the services and facilities necessary for an economy to function. For example, an entity may refer to a business, such as a producer or transporter of energy products, such as an oil refiner, a power company, or an oil & gas distributer. As used herein, “facility” refers to the physical unit of the entity capable of providing goods or services. For example, where an entity includes an oil refiner, a facility may include the oil refinery and the supporting physical operations of other entities, such as the goods and services provided by a supplier, manufacturer, or the like.

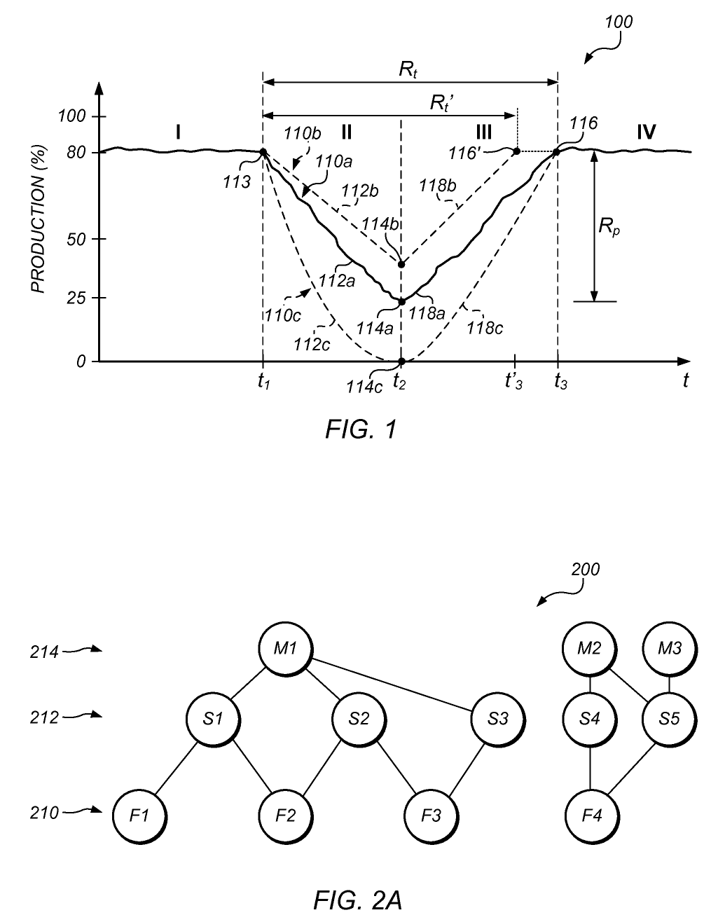

Turning now to FIG. 1, depicted is a graph 100 that illustrates production of an entity over a period of time. In one embodiment, graph 100 is representative of an energy facilities production/output over a given time period (t). The depicted production may be indicative of a refinery or similar facilities actual production, production capacity, or expected production. “Actual production” may include measured/recorded values of production that have already occurred or are currently occurring. “Production capacity” may be indicative of a maximum rate or volume of products that an entity is capable of producing. This may include an absolute maximum rate or volume of products that an entity is capable of producing under normal conditions and/or extraordinary conditions. For example, normal conditions may include the use of a normal sized workforce and equipment. Extraordinary conditions may include additional/specialized workforce and equipment. “Expected production” may be indicative of estimated future production, or estimates of production in certain hypothetical scenarios. For example, expected production may include an estimate of production in the event one or more facilities of the entity are operating at a reduced capacity due to a catastrophic event. Expected production may include estimates that are derived analytically (e.g., calculated based on assessment of available data), or may include estimates based on production experienced during similar conditions that have already occurred, or a combination thereof. For example, to determine the expected production following a hypothetical disrupting event, analysis may include providing an estimate based on data provided regarding the facilities ongoing operations and/or providing an estimate based on passed conditions, such as a similar disrupting event.

In one embodiment, production data is acquired via surveys of available data as well as surveys of an entity personnel regarding how the entity operates. For example, in one embodiment, the production data may be provided directly from an entities past production data, via surveys of individuals within the entity, surveys of individual who work with the entity, such as suppliers, via predictive modeling, or a combination thereof. In some embodiments, production data may be adjusted to account for expected fluctuation in production that may not be readily apparent. For example, as described herein, one embodiment may include increasing or reducing expected production output based on whether or not a conflict is detected within a supply chain for a facility. In one embodiment, a conflict may include two or more facilities relying on common suppliers in the case of a disrupting event. A common supplier may create a bottle neck in the supply chain when compared to an instance where a non-common supplier is relied on. In other words, there may be a greater potential that a common supplier can not provided the needed resources to multiple facilities.

In the illustrated embodiment, graph 100 depicts production (y-axis) versus time (x-axis). Production is provided a as a percentage production output. The production percentage may be indicative of a percentage of the maximum production capacity of the facility. For example, a refinery operating at rate 80,000 barrels per day while having a normal maximum capacity of 100,000 barrel per day, may be said to have an 80% production output. Other embodiments may include various other assessments of production output. For example, an embodiment may assess the actual production output. Thus, the same refinery could be said to have an 80,000 barrel per day production output. Further, production may be based on various other scales. In one embodiment, production may be expressed as a percentage of what a similar facility is expected to produce. For example, production for a single facility may be expressed as a percentage of the average production for several facilities, such as an average for all of the refineries in a country. Further, production may be expressed in various units or types of products. In an embodiment that relates to refineries, for instance, units may include as barrels, cubic feet, British Thermal Units (BTU's), and include various products, such as Liquid Petroleum Gas (LPG), gasoline (Petrol), Kerosene, Naphtha, diesel fuel, fuel oils, lubricating oils, paraffin wax, asphalt, petroleum coke, and may be expressed over varying periods, such as production over of the course of an hour, week, or month, as opposed to a single day. Other embodiments may include other types of facilities and units that appropriately reflect their rates of production. For example, facilities may include power plants having production expressed in Mega Watts (MW), and resource transportation facilities, such as natural gas transportation and unloading facilities, having production expressed in cubic-meter per hour (m³/h) or Million Standard Cubic Feet per Day (MMscf/d). Similar techniques can be applied to any type of production facility in various other industries, such a food production, manufacturing, transportation, and medical treatment.

In graph 100, the x-axis is divided into a first time period (I), a second time period (II) following first time period (I), a third time period (III) following second time period (II), and a fourth time period (IV) following third time period (V). First time period (I) ranges from a start of the x-axis (e.g., a time of zero or the start of time for first period (I)) to a first time (t₁). Second time period (II) ranges from first time (t₁) to a second time (t₂), and third time period (III) ranges from second time (t₂) to a third time (t₃). Fourth time period (IV) includes the period after third time (t₃).

In one embodiment, first time period (I) may be indicative of a time period prior to a disrupting event. For example, first time period (I) may be indicative of a normal period of operation for a facility operating at a normal production rate. For instance, in the illustrated embodiment, production is at about 80% of normal maximum capacity. As depicted in the illustrated embodiment, during a normal period of operation, production may remain relatively constant. For example, in the illustrated embodiment, although small fluctuations in production occur on a regular basis, the overall slope of production in first time period (I) remains flat (e.g., a slope of about zero). This may be considered typical as the small fluctuation may account for small variations, such as day-to-day variations in production that do not substantially affect on the long term production. In some embodiments, the first period may include an increasing or decreasing slope as new facilities are added or removed in accordance with plans to increase or decrease production. In one embodiment, the depicted production may be based on the actual or expected production capacity, or a combination thereof. For example, production in first time period (I) may be based on current levels of production, a prior level of production, an average of prior production over similar prior periods, an average of prior and expected production, or an expected production.

In one embodiment, first time (t₁) may be representative of point in time at which one or more disrupting events occur. In other words, first time (t₁) may be indicative of start of a production disruption. For example, (t₁) may include a time where production is reduced or shutdown prior to, during, or shortly after a natural disaster, a terrorist attack, or a catastrophic event, such as a fire, that causes a portion or all of the facility to be taken off-line such that it does not produce at a maximum or even normal capacity. Thus, first time (t₁) may be indicative of a point in which production starts to decline as a result of a disrupting event.

In one embodiment, second time period (II) may be indicative of a time period during which production output is initially affected by the disrupting event. For example, second time period (II) may be indicative of a period of decline of production. In the illustrated embodiment, the negative slope of the production rate is indicative of falling rate of production between first time (t₁) and second time (t₂). The slope of the production may be based on actual or expected production capacity, or a combination thereof. In the illustrated embodiment, three lines are depicted having different slopes. A first production curve 110a includes a first line 112a that is substantially linear and has a negative slope indicative of a falling production over time from an initial production level 113 first time (t₁) to a minimum production level 114a at second time (t₂). A second production curve 110b includes a second line 112b that is substantially linear and has a negative slope indicative of a falling production over time from initial production level 113 at first time (t₁) to a minimum production level 114b at second time (t₂). Second line 112b has a negative slope that is less negative than the slope of first line 110a. A third production curve 110c includes a third line 112c that is non-linear over at least a portion of second time period (II) and has an overall negative slope indicative of a falling production over time from initial production level 113 at first time (t₁) to a minimum production level 114c at second time (t₂). In the illustrated embodiment, third line 112c is more negative at an early time period shortly after the disrupting event at first time (t₁), and begins to become less negative (e.g., flatten out) as it approaches second time (t₂). Third line 112c may be representative of production that initially falls rapidly and begins to flatten as production approaches a minimum level, such as almost zero percent of production.

In the illustrated embodiment, a less negative slope may be indicative of a rate of production that is not falling as rapidly as compared to a more negative slope. For example, second line 112a is indicative of a slower rate of reduction in production than third line 112c. Typically, a less negative slope, also referred to as a shallow slope or shallow decline in production, is desirable because it indicates that production is less affected by the disruption as compared to a more negative slope. In other words, production rates remain relatively steady or at least do not fall off as rapidly.

In one embodiment, the depicted production may be based on the actual or expected production, or a combination thereof. For example, production in second time period (II), represented by one or more of lines 112a, 112b and 112c, may be based on a prior levels of production experienced as a result of similar disruptions, an average of prior production over similar prior periods, or an average of prior and expected production. Further, a single representation may be provided by averaging multiple scenarios. For example, depicted line 112a may be representative of an average of lines 112b and 112c, which themselves may be representative of actual or expected production levels. Other embodiments may include any number of data sets (e.g., lines) or averages of data sets for consideration/representation of production during second time period (II).

In one embodiment, second time (t₂) may be representative of point in time in which one or more resolutions to the disruption event occur and/or production begins a sustained return to normal production levels similar to production levels prior to or at the time of the disruption (e.g., initial production level 113). Second time (t₂) may be indicative of a point when facilities are repaired, new equipment is installed, raw materials are returned for production, facilities are brought on-line, or production otherwise begins to ramp upward. Thus, second time (t₂) may be indicative of a point in which production starts to increase as a result of a long-term sustainable solution to the disrupting event that can restore production to normal or near normal levels of production.

In one embodiment, third time period (III) may be indicative of a change in production from minimum level 114a, 114b, and 114c at second time (t2) to a restored production level 116 or 116′ at third time (t₃ or t₃′) that is at or near a normal or initial production level 113 at first time (t1). In the illustrated embodiment, each of curves 110a, 110b and 110c include lines 118a, 118b and 118c having a positive slope from a minimum level 114a, 114b, and 114c, respectively, at second time (t2) to a restored production level 116 or 116′ at third time (t₃ or t₃′). The positive slope may be indicative of a rising rate of production from second time (t₂) to third time (t₃). A first line 118a is substantially linear line having a positive slope indicative increasing production from a minimum production level 114a at second time (t₂) to a restored production level 116 at third time (t₃). A second line 118b is substantially linear line having a positive slope that is less positive than the slope of first line 118a. In the illustrated embodiment, second line 118b is indicative increasing production from a minimum production level 114b at second time (t₂) to a restored production level 116 at third time (t₃′) before third time (t₃). A third line 118c is non-linear line having a net positive slope that is almost flat, with production reaming near minimum production level 114c, shortly after second time (t₂), and that is more positive as it approaches restored production level 116 at third time (t₃). Line 118c may be representative of production rate that requires some initial start-up period of no or low production, as indicated by the initial flat portion of line 118c. A more positive slope may be indicative of a rate of production that is increasing rapidly as compared to a less positive slope. For example first line 118a indicates a more rapid increase in production than second line 118b. Typically, a more positive slope (e.g., a steep slope) is desirable during the third time period (III) because it indicates that production is more rapidly returning to normal or restored production levels.

In one embodiment, the depicted production in third time period (III) may be based on the actual or expected production, or a combination thereof. For example, production in third time period (III) represented by one or more of lines 118a, 118b and 118c, may be based on a prior levels of production experienced as a result of similar disruptions and/or resolutions, an average of prior production over similar prior periods, or an average of prior and expected production. Further, a single representation may be provided by averaging multiple scenarios. For example, depicted line 118a may be representative of an average of lines 118b and 118c, which themselves may be representative of actual or expected production levels. Other embodiments may include any number of data sets (e.g., lines) or averages of data sets for consideration/representation of production during third time period (III).

The depicted production in fourth time period (IV) may be indicative of restored production levels. For example, in the illustrated embodiment, after third times (t₃ and t₃′), the production levels remains at or near 80%, which similar minor variations as provided in first time period (I). In one embodiment, the depicted production in fourth time period (IV) may be based on the actual or expected production, or a combination thereof. For example, production in fourth time period (IV) may be represented by one or more lines, may be based on a prior levels of production experienced as a result of similar disruptions and/or resolutions, an average of prior production over similar prior periods, or an average of prior and expected production. Further, a single representation may be provided by averaging multiple scenarios. Other embodiments may include any number of data sets (e.g., lines) or averages of data sets for consideration/representation of production during fourth time period (IV).

In some embodiments, it may be useful to provide graph 100 depicted in FIG. 1 and related information to a user. Providing information may enable a user to readily assess the provided information. Graph 100 may include various features to enable a user to readily assess the production or potential/estimated production for one or more facilities before and/or after a disrupting event and/or a solution to a disrupting event. For example, in one embodiment, graph 100 may be displayed in the graphical display of a computer system or provided in a similar graphical representation (e.g., as a printout), so that a user can readily assess and all of the data provided in graph 100. A user may visually assess time periods (I) and (II) to determine how much and how quickly production is expected to fall after a disrupting event. In one embodiment, only a portion of graph 100 may be displayed. For example, where a user is only concerned with the decrease and/or increase in levels of production after a solution is provided, only second time period (II) and/or third time period (III) may be displayed. Further, embodiments may include any combination of information.

In one embodiment, graph 100 may include one or more curves for a single facility or for multiple facilities. For example, in one embodiment, graph 100 may include a single curve that extends across all four time periods. The single curve may be indicative of production at a single facility, the production for a set of facilities, the production for a segment of an industry, the production for an entire industry, or the like. In one embodiment, graph 100 may include a multiple curves that extend across one or more of the four time periods. The multiple curves may be indicative of different estimates of production for a single facility, production for a set of facilities, the production for a segment of an industry, the production for an entire industry, or the like. Such an embodiment may enable a user to readily assess various estimates simultaneously, as well as assess how multiple facilities may contribute to production. In one embodiment, a line may be highlighted or otherwise differentiated from the other provided lines. For example, in the illustrated embodiment, curve 110a is a solid line and lines 110b and 110c are dashed. In one embodiment, one or more highlighted lines may be indicative or an overall average, a most or least reliable production curve, or a user selected curve. Such embodiments may enable rapid assessment of data via the visual depiction of graph 100.

In certain embodiments, it may be useful to provide additional indicators and/or graphical representations that can enable a user to readily assess large amounts of information, such as the information provided in graph 100. For example, a user may desire to assess how a facility will react to a disrupting event with or without a visual depiction. In other words, it may be useful for a user or another assessment device, such as a computer, to be provided with an index or similar indicator that can be used to assess performance of a facility. Such an index may include a concise representation of one or more portions of the data provided in graph 100. A user may desire to assess the effect of the disrupting event and/or a solution to the disrupting event. For example, a user may be provided a value indicative of the decrease in production in second time period (II) otherwise referred to as survivability, and or the increase in production during third time period (III), and otherwise referred to as the resiliency.

“Survivability” may refer to how a facility or entity is negatively affected in response to a disrupting event. For example, survivability may refer to the decrease in production from about the time the disrupting event occurs, until a solution is provided that creates a sustainable return to normal/restored production rates. The data provided in second time period (II) may be indicative of the survivability. Accordingly, a user may assess survivability by viewing the data provided in graph 100. In one embodiment, survivability may be expressed as an index that is representative of how production is affected by a disrupting event. For example, a survivability index may include or at least be based on the slope of production during second time period (II). The slope used to determine the index may include levels of production at first time (t₁) and second time (t₂). For example, survivability may be based on a slope between initial production level 113 and minimum production level 114a. Other embodiments may include the survivability index being based on slope of a portion of the data in second time period (II) and/or a best fit approximation of production over second time period (II). For example, in one embodiment, the survivability index may be based on the slope of a best fit of all or a portion of data in second time period (II).

The survivability index may be provided to the user in a numeric or similar form that enables a user to quickly assess the survivability. Expressing survivability as a number may enable a user or a computer system to rank survivability one or more facilities with respect to one another. For example, a computer system may provide an output that ranks survivability indices of one or more facilities with regard to various types of disrupting events, and/or ranks two or more facilities in comparison to one another with regard to their survivability of a particular type disrupting event. Accordingly, a user may identify facilities that meet a certain standard or threshold, and facilities that do not meet certain standards and thresholds, and thus may be candidates for sanctions and/or improvements.

In one embodiment, the survivability index may be expressed as a percentage based on rate of decline in production. The percentage may be 100% when there is no slope and 0% where the slope is substantially vertical. For example, where the production in second time period (II) remains flat and there is no determinable reduction in production, the index may be 100 or 1, and the facility may be said to have 100% survivability. Where the production in second time period (II) falls at an even rate with a slope of about 0.5, such as that depicted by line 110a, the index may be 50 or 0.5, and the facility may be said to have a 50% survivability. Where the production in second time period (II) falls off instantaneously or nearly instantaneously to 0, as would be depicted by a vertical line at first time (t₁), the index may be 0, and the facility may be said to have 0% survivability. Other embodiments may include various indices representative of a change in the rate of production during the time period following a disrupting event. For example, in one embodiment, an instantaneous fall-off in production may be represented by an index of −1, no decrease in production (e.g., a flat response may be represented by an index of 0, and increases in production may be represented by a positive index value.

“Resiliency” may refer to how a facility or entity positively responds to a disrupting event. For example, resiliency may refer to the sustained increase in production from about the time a solution is provided that creates a sustainable return to normal/restored production rates, until about the time where normal/restored production rates are restored. The data provided in second time period (II) may be indicative of the resiliency. Accordingly, a user may assess resiliency by viewing the data provided in graph 100. In one embodiment, resiliency may be expressed as an index that is representative of how production responds to the solution. For example, a resiliency index may include or at least be based on the slope of production during third time period (III). The slope used to determine the index may include production rates at second time (t₂) and third time (t₃). For example, resiliency may be based on a slope between minimum production level 114a and restored production level 116. Other embodiments may include the resiliency index being based on slope of a portion of the data in third time period (III) and/or a best fit approximation of production over third time period (III). For example, in one embodiment, the resiliency index may be based on the slope of a best fit of all or a portion of data in third time period (II).

The resiliency index may be provided to the user in a numeric or similar form that enables a user to quickly assess the resiliency. Expressing resiliency as a number may enable a user or a computer system to rank resiliency of one or more facilities with respect to one another. For example, a computer system may provide an output that ranks resiliency of one or more facilities with regard to various types of disrupting events, and/or ranks facilities in comparison to one another with regard to their survivability of a particular type disrupting event. Accordingly, a user may identify facilities that meet a certain standard or threshold, and facilities that do not meet certain standards and thresholds, and thus may be candidates for sanctions and/or improvements.

In one embodiment, resiliency may be expressed as a percentage based on rate of increase in production during third time period (III). The percentage may be 0% when there is no slope and 100% where the slope is substantially vertical. For example, where the production in third time period (III) remains flat and there is no determinable increase in production, the index may be 0, and the facility may be said to have a 0% resiliency. Where the production in third time period (III) increases at an even rate with a slope of about 0.5, such as that depicted by line 118a, the index may be 50 or 0.5, and the facility may be said to have 50% resiliency. Where the production in third time period (III) increases to normal rates instantaneously or nearly instantaneously, as would be depicted by a vertical line at second time (t₂), the index may be 100 or 1, and the facility may be said to have 100% resiliency. Other embodiments may include various indexes representative of a change in the rate of production during the time period following a disrupting event.

Although survivability and resiliency may be considered in isolation from one another for certain assessments, survivability and resiliency may be compared or combined to determine the overall impact of a disrupting event. The ability of a facility to withstand a disrupting event may be referred to as “reliability.” A facility's reliability may be higher where a disrupting event has little or no impact on production levels, and reliability may be low where a disrupting event has a significant impact on production levels. Accordingly, reliability may be expressed as a function or combination of survivability and resiliency. A facility having a high survivability, indicative of a low reduction in production, and a high resiliency, indicative of a fast return to production, may be considered to have a high reliability. A facility with a low survivability, indicative of a significant reduction in production, and a high resiliency, indicative of a fast return to restored production, or a facility with a low survivability, indicative of a low reduction in production, and a low resiliency, indicative of a slow return to restored production, may be considered to have a moderate reliability due to the high survivability/reliability offsetting or mitigating the low reliability/survivability. A facility having a low survivability and a low resiliency may be considered to have a low reliability. In certain embodiments, reliability may be adjusted up or down based on the relative levels of survivability and resiliency.

In one embodiment, a “reliability index” may be provided as an indication of how the facility reacts during the time period from the disrupting event until normal/restored production levels are obtained (e.g., a duration of the disruption referred to as a “response time”). The reliability index, may thus take into account both the survivability and the resiliency of a facility. In other words, the reliability index may account for the combination of decreases and increases in production after a disrupting event. Such a reliability index may be helpful to assess the overall response of a facility. For example, where survivability is high, giving the appearance of little effect from the disrupting event, but resiliency is low creating a significant long term impact resulting in a lengthy return to normal levels of production, a reliability index may provide a further tool for assessment that may be not readily apparent when viewing a survivability index or a resiliency index in isolation.

In one embodiment, the reliability index is based on one or both of the survivability and resiliency indices. For example, in one embodiment, the reliability index in the sum or product of the survivability and resiliency indices. In one embodiment, a weighting factor may be applied to one or both of the survivability and resiliency indices. For example, where resiliency is of less concern than survivability, the survivability index may be multiplied by one and the resiliency index may be multiplied by a value of less than one, prior to the indices being added or multiplied to provide the reliability index.

In one embodiment, the reliability index may be based on the total length of time from the disrupting event until normal sustained production is restored, also referred to as the duration of the disruption. The duration of the disruption may be referred to as a response time (Rₜ). In the illustrated embodiment, with regard to curves 110a, 110b and 110c, the response time (Rt) may include the length of time from first time (t₁) until third time (t₃ or t₃′), when production returns to normal/restored levels of production 116 and 116′. In other words, the response time is the sum of length of time of the second time period (II) and third time period (III). With regard to line 110b, the response time (Rt′) may be shorter than a response time (Rt) of curves 110a and 110c. A shorter response time may be a desirable, as it indicates reduced period of disruption and a faster return to normal/restored production levels. Accordingly, the response time (Rt′) associated with curve 110b may be desirable when compared to the longer response time (Rt) associated with lines 110a and 110c. In such an embodiment, the reliability index may be expressed as a length of time, a percentage, a number, or the like. In one embodiment, the reliability index may be expressed in hours, days, weeks, months, or years. For example, the reliability index of line 110a may be expressed as ten days where the difference in time between first time (t₁) and third time (t₃) is about 10 days. In one embodiment, the reliability index may be expressed as a number or percentage relative to a base index. For example, a base reliability index of 1 may be associated with an average response time (Rt) for a plurality of facilities being considered, and the reliability index may be expressed as a number relative to the base reliability index. For example, a reliability index may be less than 1 for facilities that return to normal production levels in less time than the average and may be expressed as a number greater than 1 for facilities that return to normal production levels in more time than the average. For example, where the average response time falls between time (t3′) third time (t3), the reliability index for a second facility associated with line 110b may be less than one, and the reliability index for first and third facilities associated with lines 110a and 110c, respectively, may have a reliability index greater than one. Thus a displayed reliability index may be used to quickly assess the actual duration of the disruption and/or the response time of one or more facilities relative to a base index, such as the average response time for multiple facilities.

In one embodiment, the reliability index may be based on a change in production during the duration of the disruption. Thus, the reliability index may be indicative of the difference between normal levels of productions and the level of production during the duration of the disruption. For example, the reliability index may include the difference between the number of units that would be produced if the normal/initial production level was maintained over the duration of the response time. For example, the change in production may include integrating normal production across the response time (Rt) to determine a normal production quantity, integrating a reduced production across the response time (Rt) to determine a reduced production quantity, and taking the difference between the normal and reduced production quantity to determine the reduced output. In such an embodiment, the reliability index may be expressed as the reduced output. For example, the reliability index may be expressed as the reduced output number, or a number or percentage relative to a base index. In one embodiment, a base reliability index of 1 may be associated with an average production for a plurality of facilities being considered. For example, a reliability index may be less than 1 for facilities that produce less than the average production for a plurality of facilities being considered, and greater than 1 for facilities that have greater production than an average production of a plurality of facilities being considered. In one embodiment, a base reliability index of 1 may be expressed as a percentage or function of normal production output for one or more facilities. For example, a reliability index may be less than 1 for facilities that produce less than they would during normal production. The reliability index may be expressed as 0.5 for a facility that produces half as much or a product over the duration of the disruption, of instance. In one embodiment, the reliability index may be expressed as the maximum change in production over the duration of the disruption. For example, the maximum change in production may be the difference between the normal/initial/restored production level and a minimum production level. In the illustrated embodiment of graph 100, the maximum difference in production for curve 110a, 110b and 110c occur at levels 114a, 114b, and 114c, respectively. Thus a reliability index for curve 110a may be expressed as a value for the maximum change in production, or the reduced production (Rp). Other embodiments may include expressing the reliability index as a number relative to an average of reduced production at multiple facilities, or as value relative to the normal production level. For example, a reliability index may be less than 1 for facilities that have a reduced production (Rp) less than the average reduced production for a plurality of facilities being considered, and greater than 1 for facilities that have reduced production (Rp) greater an average reduced production of a plurality of facilities being considered. Thus a displayed reliability index may be used to quickly assess the production of a facility relative to a base index, such as the average production or change in production for multiple facilities during the duration of a disruption.

In one embodiment, the reliability index may be indicative of a combination of multiple factors or considerations. The reliability index may take into consideration a response time (Rt), a production output, and/or changes in production levels over the duration of the disruption (Rp). In one embodiment, the reliability index may be calculated by multiplying or adding an index associated with the response time, a reduction in production, and/or the maximum change in production over the duration of the disruption. For example, two or more of the above described indices may be multiplied or added together to provide the reliability index. Thus a displayed reliability index may be used to quickly assess the production of a facility that indicative of the response time, a reduction in production, and/or the maximum change in production over the duration of the disruption (Rp). In one embodiment, weighting factors may be applied to each of the response time, a reduction in production, and/or the maximum change in production over the duration of the disruption. For example, where reduction in production is considered an important indicator in a facility's ability to withstand a disrupting event, the index for a reduction in production may be weighted more heavily than the response time and the maximum change in production over the duration of the disruption. Accordingly, weighting may be used to further enable a user to readily assess survivability, resiliency, and/or the overall reliability of one or more facilities.

As described above, providing data regarding the production of a facility may be useful for a user to assess and determine survivability, resiliency, and reliability of one or more facilities with regard to a disrupting event. Certain embodiments may include techniques to further improve the accuracy and thoroughness of the data used to assess and determine the above described indices. For example, in certain embodiments, it may be useful to acquire and assess information with regard to a single facility. In other embodiments, however, it may also be beneficial to consider an overall impact and/or interrelation of operations at one or more other facilities when assessing an impact of a disrupting event at one or more facilities. For example, where two or more facilities rely on a common supplier for goods or services, it may be helpful to know whether or not both facilities plan to rely on that single supplier upon the occurrence of a disrupting event. If two facilities are planning to use the single supplier and a disrupting event occurs simultaneously at two or more facilities, a response at one or both of the facilities may be limited if the supplier is only capable of provided goods or services to one of the facilities. In other words, a bottleneck in the supply chain may need to be accounted for to provide a complete and accurate representation of reliability at one or more facilities. In certain embodiments, the provided data and or indices resulting from the provided data may be modified based on whether or not a facility shares a common supplier with another facility that may be subject to a disrupting event at the same time, and/or require an overlap in assistance from one or more suppliers in the supply chain. For example, survivability data in the second time period and/or a survivability index may be negatively affected if another facility intends to rely on a limited supply of goods or service. A similar affect on the resiliency may occur.

FIG. 2A depicts a supply chain 200 in accordance with one or more embodiments of the present technique. Supply chain 200 may be indicative of a supply chain for a single or multiple products and services. In the case of refining operations, supply chain 200 may be indicative of all goods and services provided to a refiner from suppliers and manufactures, or may be indicative of a single item or narrow subset of items goods and services provided to a refiner from suppliers and manufactures. For example, in one embodiment, supply chain may be indicative of a supply chain for refinery catalytic crackers (“crackers”) and related goods and services.

In the illustrated embodiment, a set of facilities 210 are depicted at a lower level of supply chain 200. The include facilities F1, F2, F3, and F4. In an embodiment in which the assessed facilities include refineries, facilities F1-F4 may each be indicative of a separate refinery or refining operation. In the illustrated embodiment, a set of suppliers 212 are depicted at a mid level of supply chain 200. These include suppliers S1, S2, S3, and S4. Suppliers S1-S4 may be capable rendering certain goods or services that can be used to help provide a solution to a disrupting event. For example, suppliers can provide personnel or products to facilitate repair of a production component. In an embodiment in which facilities F1-F4 include refineries, suppliers S1-S4 may include suppliers capable of servicing, repairing or replacing certain portions of refining facilities F1-F4. For example, suppliers S1-S4 may provide for the repair, replacement, and/or manufacture of a cracker in the case one needs to be repaired or replaced. In the illustrated embodiment, a set of manufacturers 214 are depicted at an upper level of supply chain 200. These include manufacturers M1, M2, and M3. Manufactures M1-M4 may be capable rendering certain goods or services that can be used by suppliers S1-S4 and/or facilities F1-F4 to help provide a solution to a disrupting event. For example, manufactures M1-M4 may provide raw goods, such as materials, valves, pressure vessels, and the like that can be used by suppliers S1-S5 during service, repair, or replacement of certain portions of refining facilities F1-F4.

Each of the facilities, suppliers and manufacturers, may be referred to as a “node” of supply chain 200. As depicted, in certain instances, a single node may service multiple other nodes within supply chain 200. For example, supplier S1 includes a single node that services two other nodes, facilities F1 and F2. Where a single node services two or more other nodes, the node may be referred to as a “common” or “shared” node. Accordingly a supplier that services multiple facilities, such as supplier S1, may be referred to as a common or shared supplier of facilities F1 and F2. Further, facilities F1 and F2 may be said to have a shared of common supplier. As described below, a shared or common supplier may indicate a conflict in supply chain 200. Where a single node services only a single other node, the node may be referred to as an “independent” node. Accordingly a supplier that services a single facility, such as supplier S3, may be referred to as an independent supplier of facility F3.

In an embodiment in which each of suppliers and manufactures have unlimited or adequate resources to provide a solution during one or more disrupting events, an issue/conflict may not arise when two facilities have a shared supplier. For example, where facility F1 and facility F2 are both in need of a cracker, no issue/conflict may arise if supplier S1 has two crackers in inventory and is capable of providing them to facilities F1 and F2. An issue or conflict may arise, however, if facilities F1 and F2 are both in need of a cracker and supplier S1 only has one or no crackers in inventory. In such a situation, the shared supplier may be unable to immediately provide a solution to the disruption of one or both of facilities F1 and F2. Further, even if supplier S1 is capable of producing an additional cracker to help mitigate the disruption to the facilities, another potential conflict may arise if shared manufacture M1 has committed resources to another supplier, such as suppliers S2 and S3. For example, where a disrupting event requiring a new cracker has also occurred at facility F3, shared manufacture M1 may have already committed services and products to supplier shared supplier S2 or independent supplier S3, and thus may be unable to fulfill the services and/or products required by supplier S1. The above scenario illustrates a conflict in the supply chain that may occur due to shared/common nodes in the supply chain. Such conflicts in the supply chain can further increase the impact of a disrupting event. For example, if conflicts in the supply chain are present, the production rate may fall faster and recover slower than a scenario where no conflicts are present.

Detected conflicts in the supply chain may be used to assess and determine the effects a disrupting event. In one embodiment, the survivability and or the resiliency may be reduced based on the detection of conflicts in the supply chain. For example, when estimating data for use in plotting curve 110a in graph 100 of FIG. 1, the slope of line 112a may be decreased and/or the slope of line 118a may be decreased, indicating a higher rate of decrease in production levels, and/or a lower rate of return to restored production levels. Further, certain embodiments may include assessment and determination of the effects a disrupting event based on severity of one or more supply chain conflicts. For example, a facility relying on a shared supplier servicing three nodes may have a more negative impact on reliability than a shared supplier servicing two nodes. Similarly, the impact of a shared supplier may be assessed based on the ability of the shared supplier to service the lower level nodes. For example, a supply chain conflict that includes a shared supplier servicing three nodes, but that is capable of servicing all three of the nodes simultaneously, may not have as negative of an impact on reliability as a shared supplier that only service s two nodes, but is that is unable to service the two nodes simultaneously.

In one embodiment, the detection of a conflict in the supply chain may be directly applied to an index. For example, a value may be added or subtracted to the survivability index, the resiliency index, and/or the reliability index based on whether or not a conflict exits. For example, where a supply chain conflict is detected, production data of graph 100, the survivability index, the resiliency index, and/or the reliability index, or similar indicators may be modified to reflect a indicate higher rate of decrease in production levels, and/or a lower rate of return to restored production levels. Similarly, where no conflicts in the supply chain are detected, production data of graph 100, the survivability index, the resiliency index, and/or the reliability index, or similar indicators may be modified to indicating a lower rate of decrease in production levels, and/or a higher rate of return to restored production levels. Thus a reliability may be modified based the number and severity of supply chain conflicts.

In one embodiment, an index may be provided that is indicative of the supply chain for a facility. The index may be referred to as a supplier index. In one embodiment, the supply chain index is based on the absence and presence of supply chain conflicts. For example, a facility may have a higher supply index where its supply chain includes fewer conflicts such that the supplier is likely to be provided services or products that can help to reduce the negative effects of a disrupting event. In one embodiment, each supplier and or manufacture may be provided an index based on the number of lower levels nodes that it services. The index may include the inverse of the number of lower level entities serviced by a single node. For example, supplier S1 may have a node index of 0.5 (1/2), supplier S2 may have an node index of 0.5 (1/2), supplier S3 may have a node index of 1 (1/1), supplier S4 may have a node index of 1 (1/1), and supplier S5 may have a node index of 1 (1/1), manufacturer M1 may have a node index of 0.3 (1/3), manufacturer M2 may have a node index of 0.5 (1/2), manufacturer M3 may have a node index of 1 (1/1). To determine the supplier index for each facility, a node index for each potential supply route (e.g., the chain from the facility to an ultimate supplier, such as a manufacture) may be added to one another. For example, in one embodiment, facility F1 has a supplier index of 0.8, facility F2 has a supplier index of 1.6, facility F3 has a supplier index of 2.1 and facility F4 has a supplier index of 5. In certain embodiments, indices of each node may be increased or decreased to reflect the ability of the node to provide goods and services to the nodes which it services. For example, a shared manufacture servicing three nodes (e.g., M1), but that is capable of servicing all three of the nodes simultaneously, may have a higher index compared to a shared manufacturer that only services two nodes (e.g., M2), but that is unable to service the two nodes simultaneously.

In one embodiment, facilities may be ranked on the strength of their supply chain (e.g., the supplier index). The strength of the supply chain may refer to the likelihood that the facility will be able to obtain the necessary services and products from upper level nodes to provide a solution to the disrupting event. In one embodiment, the supplier index may be provided in the form of a table that can be assessed by a user. FIG. 2B illustrated a table 250 in accordance with one or more embodiments of the present technique. Table 250 includes facilities F1-F2 listed in a first column, a ranking of facilities F1-F2 provided in a second column 254, and a supplier index provided in a third column 256. In the illustrated embodiment, facilities are sorted by their respective supplier indices. Table 250 may enable a user to readily assess and determine the strength of a facilities supply chain which respect to other supply facilities.

In some embodiments, assessments and determinations of a facility or multiple facilities may be provided to a user to enable additional assessments and or determinations to be made. For example, a user may be provided with a display or printout of one or more of the indices described herein, such that they can readily rank or assess one or more of the facilities. In certain embodiments, the survivability index, the resiliency index, the reliability index, the supplier index, or another index may be displayed to a user. Display of one or more indices may provide a summary of production data in a concise manner than enables efficient assessment by a user without having to review all of the provided production data. Further, providing indices based on the above described techniques may provide indicators to a user that may not be readily apparent upon the review of raw production data. For example, a user may be presented with information relating to a single facility to assess and determine whether or not that facility should take additional measures in a specific area, such as addressing supply chain conflicts, to better prepare for a disrupting event. In another example, a user may be provided information relating to multiple facilities to assess and determine whether or not a particular facility, a group of facilities or an entire segment of an industry should take additional measures to address a disrupting event. The provided information may include individual evaluations one or more facilities, trending data of one or more facilities of an extended period of time, or a comparison of multiple facilities with one another.

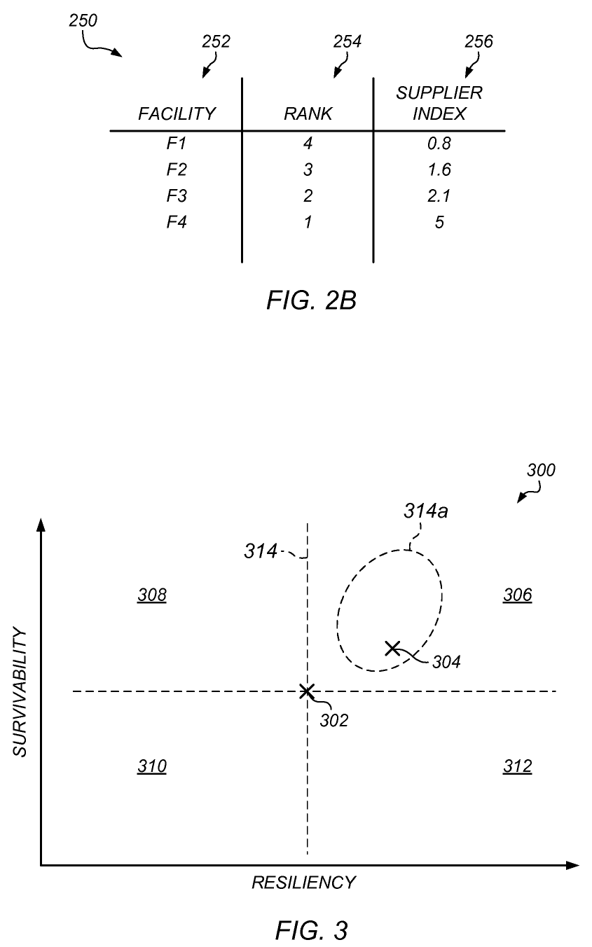

FIG. 3 depicts is a graph 300 that illustrates survivability versus resiliency. Graph 300 may be provided in a graphical display to user to enable the user to assess one or more a facilities ability to respond to a disrupting event. Graph 300 may also be used to trend changes in the ability to respond to a disrupting event. For example, a first plotted point may be indicative of a resiliency and a survivability of one or more facilities at a first time, and a second plotted point may be indicative of a resiliency and survivability at a second point in time. A user may be able to quickly assess and determine whether or not one or both of resiliency and survivability have increased or decreased by comparing the position of the first plotted point to the second plotted point. For example, in the illustrated embodiment, a first point 302 is plotted near a center of graph 300 and a second point 304 is plotted in a first region (quadrant) 306. In one embodiment, location of the second point 304 in the first quadrant relative to the first point 302 may be indicative of an increase in resiliency and an increase in survivability. As described above, an increase in resiliency and survivability may be indicative an in improvement in the ability of a facility to withstand a disrupting event (e.g., an improvement of the facilities reliability). For example, an increased survivability may indicate a slower rate of decline in production after a disrupting event, and an increased resiliency may indicate a faster rate of sustained return to normal production after a solution has been provided.

In the illustrated embodiment, graph 300 includes a second region 308, a third region 310 and a fourth region 312. The second region 308 is a quadrant of graph 300 that includes values for survivability that are higher than that of first point 302 and values of resiliency that are lower than that of second point 302. The third region 310 is a quadrant that includes values for survivability that are lower than that of first point 302 and values of resiliency that are lower than that of second point 302. The fourth region 312 is a quadrant that includes values for survivability that are lower than that of first point 302 and values of resiliency that are higher than that of second point 302. When graphically displayed, a user may be able to use graph 300 to assess and determine whether or not one or both of resiliency and survivability have increased or decreased by determining which region a point is located in relative to another point. In one embodiment, a boundary 314 of one or more quadrants may be provided to further increase the ability to assess and determine one point's relation to another.

In one embodiment, graph 300 may include variations of displayed regions to further enhance the ability of a user to readily identify certain implications of various regions of the graph. For example, in place of or in addition to boundary 314, graph 300 may include displayed boundaries that indicate characteristics relating to survivability and resiliency. In one embodiment, the displayed boundary may indicate an expected location or a desirable location of a point on the graph. For example, a second boundary 314a may define a region for acceptable values. In the illustrated embodiment, for instance, a second point 304 is located within second boundary 314a, and would thus be acceptable. In one embodiment, the displayed boundary may indicate an expected or desirable location relative to another point on the graph. For example, boundary 314a may be indicative of where survivability and resiliency is expected be after a year has passed, with respect to when first point 302 was assessed, and improvements in the reliability have been made. Accordingly, where second point 304 is representative of resiliency and survivability after a year, the facility may be deemed acceptable. If improvements were outside of the region 314a, the facility may be deemed to have not met the requirements, or the improvements may be so great that they may be considered inaccurate.

In one embodiment, boundaries 314 or 314a may be displayed relative to a single point, multiple points, or even all points displayed. In one embodiment, boundaries 314 and 314a may be dynamically displayed for a point when the point is selected by a user. For example, boundary 314 and/or boundary 314a may be displayed when a user locates a pointer over the displayed first point 302. Accordingly, when one or more points and one or more boundaries are displayed a user may readily assess and determine whether or not improvements have been made with regard to resiliency and survivability.

In one embodiment, first point 302 may be indicative of a first facility's survivability and resiliency, and second point 304 may be indicative of a second facility's survivability and resiliency. Other embodiments may include any number of points indicative of other facilities' survivability and resiliency. Accordingly, graph 300 may be used to assess and determine the survivability and resiliency of facilities relative to one another.

In certain embodiments, multiple points indicative of survivability and resiliency may be plotted to provide for trending of resiliency and survivability over a period of time. For example, a first series of points may be plotted that are representative of the survivability and resiliency for a plurality of facilities at a first point in time, and a series of points may be plotted that are representative of the survivability and resiliency for a plurality of facilities at a second point in time. When provided on a single plot, a user may be able to readily assess and determine a trend in the survivability and resiliency over a period of time. For example, where the second series of points indicates an increase in resiliency and survivability, it may be determined that a set of facilities are improving their ability to withstand a disrupting event. In certain embodiments, plots may include the addition of best fit line and or averages of the series of points to further enable a user to assess and determine how survivability and resiliency are changing over a period time. Such a plot may enable a user to assess the trends of an entire industry, for instance.

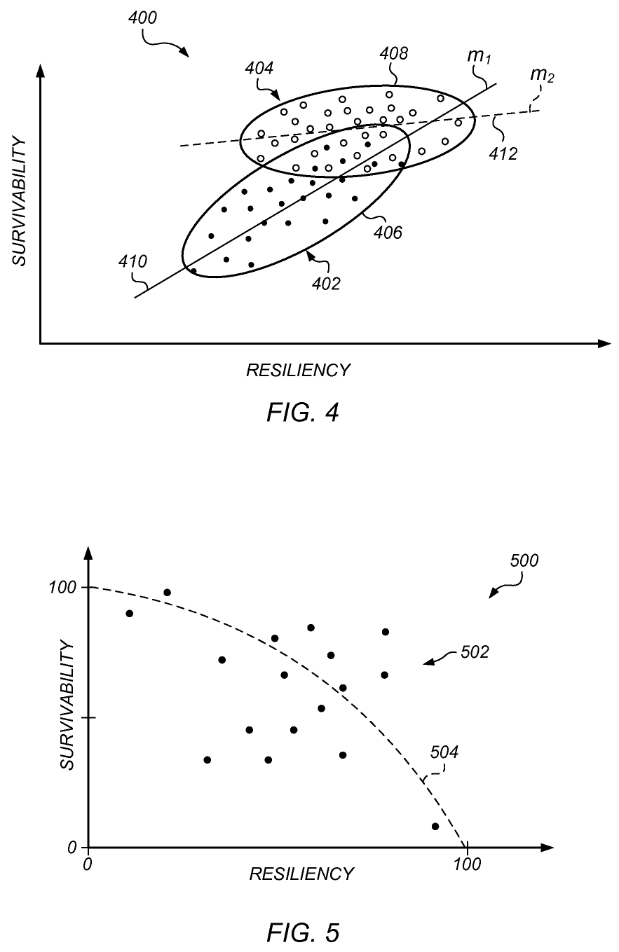

FIG. 4 includes a graph 400 that illustrates survivability versus resiliency. Graph 400 may be provided in a graphical display to user to enable a user to assess one or more a facilities ability to respond to a disrupting event. In the illustrated embodiment, multiple points are plotted that enable a user to assess and determine trends in survivability and resiliency. In the illustrated embodiment, a first series of points 402 and a second series of points 404 are plotted. First series of points 402 may represent survivability and resiliency values taken at multiple facilities at a first point in time. Second series of points 402 may represent survivability and resiliency values taken at multiple facilities at a second point in time. In the illustrated embodiment, a first and second boundary 406 and 408 is provided around each series of points 402 and 404. Further best fit lines 410 and 412 are provided for each series of points 402 and 404, respectively. Best fit line 410 includes a first slope (m1) and best fit line 412 includes a second slop (m2). A user may readily assess and determine a trend in data from the first period time to the second period of time. Further, a user may assess trends in changes of survivability and resiliency based on the slopes (m1) and (m2) of lines 410 and 412. For example, the lower slope (m2) may be indicative a smaller variance in survivability and a larger variance in resiliency when compared to the first series of points 402 and the associated slope (m1) of line 410.

In certain embodiment, the combination of survivability and resilience may be considered to determine where a facility ranks in accordance with respect to other facilities. For example, a reliability index of a facility may be compared to rank facilities with respect to one another. In one embodiment, a threshold level may be set to determine which facilities meet and which facilities fall below a given level of response. In one embodiment facilities that fall on one side of the threshold may be required to make improvements or other wise address their ability to respond to a disrupting event, and facilities that fall on the other side of the threshold may be considered to meet response requirements, and, thus are not required to make any improvements. The threshold level may be set to a particular value based on a level of required reliability. In one embodiment, the threshold level is set to provide a certain number of facilities on either side of the threshold. For example, only the ten worst performing facilities may be identified based on the threshold.

FIG. 5 depicts a graph 500 that illustrates survivability versus resiliency. Graph 400 may be provided in a graphical display to user to enable a user to assess one or more a facilities ability to respond to a disrupting event. More specifically, graph 500 may provide a visual depiction of a threshold to enable a user to readily assess facilities that exceed, meet, or do not meet a threshold requirement. Graph 500 includes points 502 of survivability and resiliency for a plurality of facilities, and includes a threshold line 504. Threshold line 504 may be indicative a threshold division between combinations of survivability and resiliency that is indicative of a desired reliability, For example, in one embodiment, points located beyond threshold line 504, having higher survivability and resiliency values, may be determined as meeting or exceeding a threshold level associated with threshold line 504, and points located within the threshold line 504, having lower survivability and resiliency values, may be determined as not meeting a threshold level associated with threshold line 504. In one embodiment, threshold line 504 may be dynamically placed such that a user can move line 504 from one location to another or modify the shape of line 504 to assess and determine which facilities fall do or do not meet the threshold associated with threshold line 504.

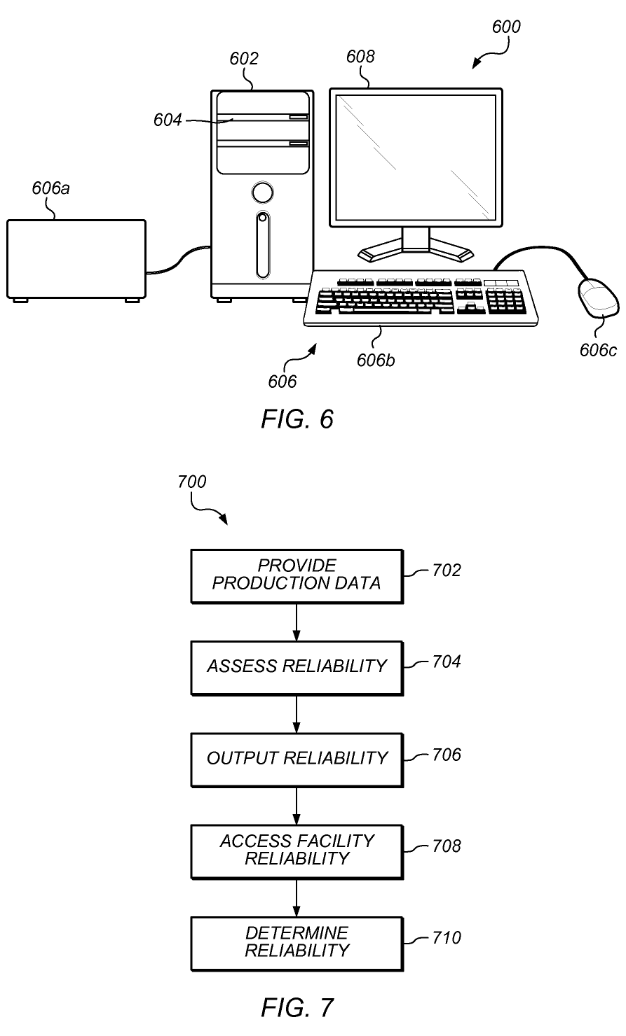

Embodiments of the present technique may be employed in various manners to provide information to a user. For example, in some embodiment information and data may be acquired, assessed, processed, and/or output by a computer system for use by other systems and/or a user. FIG. 6 illustrates an embodiment of a computer system 600 in accordance with one or more embodiments of the present technique. In the illustrated embodiment, computer system 600 includes a processing unit 602, a memory 604, peripheral devices 606, and a graphical display 608. In one embodiment, processing unit 602 includes a central processing unit or similar device that is capable of executing routines, such as program instruction typically stored on memory 604 of computer system 600. In one embodiment, memory 604 includes a computer readable storage medium capable of storing program instruction for execution by processing unit 602. In one embodiment, memory 604 includes a hard-drive, read only memory (ROM), random access memory (RAM), flash memory, a floppy disk, a CD-ROM, or the like. Memory 604 may be capable of storing various forms of data. Peripheral devices 606 may include any variety of devices that enable interaction with computer system 600. In the illustrated embodiment, peripheral devices 606 include a printer 606a, a keyboard 606b, and a mouse 606c. Printer 606a may be capable or providing a printout of information, such as graphical representations of data (e.g., graphs and tables) provided herein. Display 608 may be capable of providing a graphical display of data or images. In the illustrated embodiment, display 608 includes a computer monitor that is capable of displaying information to a user. Accordingly, a user may view and assess information provided graphical display 608, such as graphical representations of data (e.g., graphs and tables) provided herein. In certain embodiments, display 608 may also include a touch screen that enables a user to provide inputs to computer system 600.

Turning now to FIG. 7, depicted is a flowchart that illustrates a method 700 of assessing a reliability of an entity, in accordance with one or more embodiments of the present technique. One ore more portions of method 700 may be performed by or on computer, such as computer system 600. For example, a memory may include program instruction stored thereon configured to execute one or more portions of method 700.

In one embodiment, method 700 includes providing production data, as depicted at block 702. Providing production data may include acquiring data relating to a facilities production levels. The data may include actual production, production capacity, and expected production of the like. Production data may include data relating to how a facilities production levels before, during and/or after a disrupting event. Production data may include data indicative of an expected decline in production after the disrupting event and data indicative of an expected restoration of production to normal/restored levels after the disrupting event. In one embodiment, the provided production data is acquired via data provided directly by the facility. In one embodiment, the provided production data may be acquired via surveys of a facility. For example, provided production data may be acquired via asking questions of representative knowledgeable about various operations of the facilities, For example, a survey may include asking representatives within the entity, entity representatives who have worked with suppliers, and/or suppliers to answer questions and to provide information concerning organizational processes or systems used by the entity and/or the supplier. In certain embodiments, the production data, includes information concerning organizational processes or systems used by the entity and/or the supplier, is used to provide a representation of how an entity's production may be affected by a disrupting event.

Method 700 also includes assessing reliability, as depicted at block 704. In one embodiment, assessing reliability includes assessing how the facility responds to a disrupting event. For example, in one embodiment, a facility that is expected to experience less of a negative impact in the wake of a disrupting event is considered to have a higher reliability than a facility that is expected to experience a more negative impact in the wake of a disrupting event. In one embodiment, assessing reliability includes assessing a response time, a minimum level of production, survivability, a resiliency, or the like. In one embodiment, assessing reliability includes assessing and determining one or more indices that can be provided to user. For example, in one embodiment, a reliability index is based on a survivability index and a resiliency index, as described above. In one embodiment, a reliability index or a related index, such as the survivability index or the resiliency index, is based on whether or not a supply chain conflict exists, and/or the extent of the conflict. For example, as described above, reliability may be reduced or increased based on a supplier index.

Method 700 also includes outputting reliability, as depicted at block 706. In one embodiment, outputting reliability includes outputting any one of the indices described herein. For example, an embodiment may include displaying in a graphical display of a computer system, a number indicative of a reliability index, a survivability index, a resiliency index, a supplier index, or the like. In one embodiment, the displayed indices may be provided directly to a user in numeric form. In one embodiment, the a display may include a table or similar arrangement of data relating to facilities that includes placement and/or ranking of facilities based on one or more indices. For example, a graphical display may include a table similar that of table 250 depicted in FIG. 2B. In one embodiment, outputting reliability may include displaying data, such as graph or indices that may be indicative or can be used to assess and/or determine a reliability of facility. For example, in one embodiment, outputting reliability may include displaying graphs and plots similar to those depicted and described with respect to FIGS. 1, 2A, 3, 4, and 5. In one embodiment, outputting reliability includes displaying one or more representations of production data, similar to those depicted and described with respect to FIGS. 1, 2A, 3, 4, and 5, in a graphical display of a computer system.

Method 700 also includes assessing facility reliability, as depicted at block 708. In one embodiment, assessing facility reliability includes assessing the reliability of a facility based on the output reliability. For example, in one embodiment, a user may be able to assess the relative reliability of a single facility or multiple facilities by simply viewing and comparing plots of various indicators. In one embodiment, a visual comparison may be made between two points to assess relative reliability (e.g., survivability and resiliency) based on a plot, such as that depicted and discussed with respect to FIG. 5. Other embodiments may include a relative comparison of various indicators production data by visual inspection of data displayed in a similar manner to that depicted and described with respect to FIGS. 1, 2A, 3, 4, and 5.

In some embodiments, method 700 includes determining reliability, as depicted at block 710. In one embodiment, the determination may include determining reliability and making a further assessment and determination of which facilities need to address production issues to ensure production across a critical infrastructure does not fall below critical levels. For example, in one embodiment, facilities having reliability or similar indices that fall below a threshold level may be required to address production issues. In one embodiment, the issues to be addressed may be based on various other issues identified in the production data. For example, where a supplier index indicates a substantial supply chain conflict, a facility may be required to address and reduce the potential supply chain conflict. Such techniques may be particularly useful to help ensure that one or more facilities, entities, or the like of a critical infrastructure remain viable during a disrupting event, such as a natural disaster, sabotage, a terrorist attack, or catastrophic event.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. The words “include”, “including”, and “includes” mean including, but not limited to.

What is claimed is:

1. A method of assessing reliability of an infrastructure entity, comprising:
providing production data for an entity;
assessing how the entity is expected to respond to a disturbing event;
adjusting production data based on how the entity is expected to respond to the disturbing event;
providing, in a graphical display of a computer system, a display indicative of the adjusted production data;
determining a reliability of the entity based on the adjusted production data; and
recommending an action for the entity based on the display indicative of the determined reliability.

2. The method of claim 1, wherein assessing how the entity is expected to respond to a disturbing event comprises assessing a supply chain of the entity to identify one or more supply chain conflicts.

3. The method of claim 1, wherein assessing a supply chain of the entity to identify a supply chain conflict, comprises assessing whether or not the entity supply chain comprises one or more shared nodes.

4. The method of claim 1, wherein the determined reliability is based on survivability.

5. The method of claim 1, wherein the determined reliability is based on a resiliency.

6. The method of claim 1, wherein determining a reliability comprises determining a reliability index based on a survivability index and a reliability index.

7. The method of claim 1, wherein providing a display indicative of the adjusted production data comprises providing a graph of survivability versus resiliency.

8. The method of claim 7, wherein recommending an action for the entity based on the display indicative of the determined reliability comprises determining a relative value of reliability based on the display, and recommending an action for the entity based on the determined relative value of reliability.

9. The method of claim 1, wherein providing a display indicative of the determined reliability comprises providing a table of one or more entities and indicating their reliability relative to one another.

10. The method of claim 1, wherein the reliability of the entity is higher for an entity having production level that is less affected by the disturbing event, and is lower for an entity having production level that is more affected by the disturbing event.

11. A computer readable storage medium comprising computer instructions stored thereon, wherein the computer instruction are configured to be executed to implement a method of assessing reliability of an infrastructure entity, comprising:
providing production data for an entity;
assessing how the entity is expected to respond to a disturbing event;
adjusting production data based on how the entity is expected to respond to the disturbing event;
providing, in a graphical display of a computer system, a display indicative of the adjusted production data;
determining a reliability of the entity based on the adjusted production data; and
recommending an action for the entity based on the display indicative of the determined reliability.

12. A method of assessing risk of an infrastructure entity, comprising:
assessing a supply chain of the entity;
determining whether or not the supply chain of the entity comprises a conflict;
adjusting production data for an entity based on the whether or not the supply chain of the entity comprises a conflict, wherein the production data comprises information related to production levels after the occurrence of a disrupting event; and
displaying, in a graphical display of a computer system, a graphical representation of the adjusted production data.

13. The method of claim 12, wherein determining whether or not the supply chain of the entity comprises a conflict comprises determining whether or not two or more entities reference one or more shared nodes of the supply chain.

14. The method of claim 12, wherein adjusting the production data for an entity based on the whether or not the supply chain of the entity comprises a conflict comprises adjusting a supplier index associated with the entity.

15. The method of claim 14, wherein the supplier index is indicative of the number of conflicts in the supply chain of the entity.

16. The method of claim 12, wherein adjusting the production data for an entity based on the whether or not the supply chain of the entity comprises a conflict, comprises modifying data indicative of survivability.

17. The method of claim 12, wherein adjusting the production data for an entity based on the whether or not the supply chain of the entity comprises a conflict, comprises modifying data indicative of resiliency.

18. The method of claim 12, wherein adjusting the disruption data for an entity based on the whether or not the supply chain of the entity comprises a conflict, comprises modifying a graphical display of the adjusted production data.

19. The method of claim 12, further comprising determining a supplier index based on the adjusted data.

20. The method of claim 19, further comprising ranking the entity with respect to other entities based on a comparison of the supplier index of the entity to supplier indices of one or more other entities.

21. The method of claim 20, further comprising identifying one or more entities as needing to modify their supply chain based on the ranking.
